(19) United States
(12) Patent Application Publication
(10) Pub. No.: US 2013/0270727 A1
(43) Pub. Date: Oct. 17, 2013

(54) PROCESS OF FORMING A CONCRETE COLUMN

(71) Applicant: Jose Antonio Bauer-Juarez, Winter Park, FL (US)

(72) Inventor: Jose Antonio Bauer-Juarez, Winter Park, FL (US)

(21) Appl. No.: 13/446,031

(22) Filed: Apr. 13, 2012

(51) Int. Cl. E04B 1/16; B29C 63/26; B28B 7/36

(52) U.S. Cl. 264/32; 249/187.1

(57) ABSTRACT

A process of forming a concrete column using a concrete column forming tube lined with a flexible and compressible elastomer sleeve having a randomly dispersed rigid granular material encapsulated therein to form a concrete column having a textured surface. The flexible and compressible elastomer sleeve is formed by mixing a liquid elastomer with a rigid granular material and applying the mixture over a textured generally cylindrical form and curing the liquid elastomer. A colorant may be applied to the inside surface of the flexible and compressible elastomer sleeve to form a concrete column having a colored and textured surface.

### BACKGROUND OF THE INVENTION

This invention relates to the process of forming a concrete column having a textured and colored surface and especially to a process of making an elastomer mold sleeve for lining a concrete column forming tube prior to pouring the concrete to make the concrete column.

Concrete columns are typically constructed using a concrete column forming tube which is positioned on site for forming the concrete column. The concrete column form tube is then filled with concrete to form a concrete column. The concrete column forming tube is then stripped from the cured concrete column. Concrete column forming tubes are commonly constructed of partially overlapped or spirally wound plies of paper adhered together and defining an inside wall surface of a predetermined diameter. These forming tubes receive poured concrete therein which is cured and set up to produce a concrete column. The forming tubes are then stripped away leaving the produced concrete column. In the typical spirally wound concrete column forming tube construction, the spiral seam lines are present on the inside wall surface of the forming tube which results in spiral lines molded on the outside surface of a produced concrete column.

In the prior U.S. patent to Rummage et al., U.S. Pat. No. 4,957,270, a flexible cylindrical liner is positioned in a generally friction-fit relationship within a concrete forming tube. The flexible liner which is constructed of a paperboard layer is used to cover the spiral seam lines in the inside wall surface of a rigid tube to prevent the formation of seam lines on the outside surface of the produced concrete column.

In U.S. Pat. No. 4,595,168 to Goodwin, a separate all plastic tubular liner is positioned inside a rigid cylindrical tube of partially overlapped spirally wound plies of paper adhered together in order to eliminate the spiral seam lines on the surface of the concrete column and provide a moisture barrier on the inside wall of the forming tube.

In the U.S. patent to Weekers, U.S. Pat. No. 5,328,142, a concrete column forming tube is fabricated with a thin flexible paper wall which is collapsible into a flat shape which may be wound into a reel to facilitate transport, handling and storage.

In U.S. Pat. No. 5,874,016 to Bacon, Jr. et al., a concrete column forming tube has a smooth inside coated surface to produce a concrete column which eliminates the spiral seam lines in the resulting concrete column.

In the van de Camp U.S. Pat. No. 6,467,749, a concrete column forming tube tear strip is formed therein which enhances the removal of the concrete column forming tube from the formed concrete column.

Other concrete column forming tubes may be seen in the E. L. Hart, Jr. et al. U.S. Pat. No. 2,914,833 for a paper tube forming a concrete column and in the B. D. Clarkson U.S. Pat. No. 2,836,874 for a paper tube concrete form. The E. S. Reid U.S. Pat. No. 2,888,043 is a multiple section concrete forming paper tube while the U.S. Patent Application Publication No. US 2006/0016150 to Fournier is for a paperboard formwork and method for forming concrete structures which uses a tubular envelope as a wall assembly nested within the axial hollow of the tubular envelope.

The present invention is directed towards a process of forming a concrete column utilizing a standard concrete column forming tube and has a flexible and compressible sleeve shaped to line the inside of the tube to produce a concrete column having a textured and colored surface. A concrete column is made with a desired surface texture and color in one easy step which does not have the seam lines of a typical concrete column forming tube and produces a column which does not look like formed concrete.

### SUMMARY OF THE INVENTION

A process of forming a concrete column having a textured and colored surface uses a concrete column forming tube lined with a flexible and compressible elastomer sleeve having randomly dispersed rigid granular material encapsulated therein. The flexible and compressible elastomer sleeve is formed by mixing a liquid elastomer, such as a latex or silicone elastomer, with a rigid granular material, such as granular pumice, and applying the mixture over a textured, generally cylindrical form and curing the liquid elastomer. A colorant may be applied to the surface of the flexible and compressible elastomer sleeve to form a concrete column having a colored and textured surface. The process of forming a concrete column having a textured surface includes the selecting of a rigid elongated concrete column forming tube having a generally smooth interior wall. A cylindrical form is made having a textured surface thereon and has a circumference slightly smaller than the concrete column forming tube circumference. Liquid latex or silicone or other elastomeric material is mixed with a rigid granular material, such as a granular pumice, and the mixture is coated on the outside of the cylindrical form and cured thereon to form a flexible column forming tube mold sleeve having rigid particles dispersed therein. The latex having the rigid granular material therein is cured to form a resilient and compressible latex having the rigid granular material randomly dispersed therein which is removed from the textured generally cylindrical form. The elastomer sleeve may have a predetermined colorant applied to the inside thereof. The elastomer sleeve is attached to the inside of a concrete column forming tube and concrete is poured into the concrete column forming tube having the mold sleeve attached therein. The concrete is then cured to form a concrete column. The column forming tube and mold sleeve is then removed to produce a concrete column having a textured surface.

A flexible and compressible sleeve for a concrete column forming tube has a generally cylindrical shape and is formed of an elastomeric material, such as latex or silicone, and has randomly dispersed rigid granular material, such a pumice, encapsulated therein. The sleeve has a textured surface and may have a colorant on the inside surface thereof to form a sleeve mold sized to line the inside wall of a concrete column forming tube so that a concrete column can be formed having a textured and colored surface. The resilient material sleeve will compress when concrete is poured into the column forming tube to compress against the rigid granular materials encapsulated therein to form a textured surface on the surface the concrete column.

### BRIEF DESCRIPTION OF THE DRAWINGS

The accompanying drawings which are included to provide a further understanding of the invention incorporates and constitutes a part of the specification to illustrate an embodiment of the invention and together with the description serves to explain the principles of the invention.

In the drawing:

FIG. 1 shows a perspective view of a concrete column forming tube;

FIG. 2 is a perspective view of tubular form having a textured surface;

FIG. 3 is a perspective view of the tubular form of FIG. 2 having a mixture of a liquid elastomer and a rigid granular material applied thereto;

FIG. 4 is a perspective view of the tubular form of FIGS. 2 and 3 having the cured elastomer sleeve being removed from the form;

FIG. 5 is a partial sectional view of a section of the elastomer sleeve of FIG. 4;

FIG. 6 is a perspective view of a concrete column forming tube having the mold liner attached therein and being filled with concrete; and

FIG. 7 is a perspective view of the formed concrete column having the concrete column forming tube and sleeve liner being removed therefrom.

### DETAILED DESCRIPTION OF AN EXEMPLARY EMBODIMENT

Referring to the drawings, FIGS. 1-7, the process of forming a concrete column is illustrated. FIG. 1 shows a rigid elongated concrete column forming tube 10 which may be constructed of partially overlapping spiral wound plies of paper adhered together to define the concrete column forming tube with a predetermined inside wall 11 diameter and circumference. The inside wall 11 has a smooth surface except for the spiral wound construction lines 12. Concrete forming tubes are sold as having a predetermined inside diameter but the tubes of the same inside diameter typically have slightly differing inside diameters so that three tubes fit together to reduce the space required during shipment.

FIG. 2 shows a tubular form 13 having a textured surface 14 covering the circumference thereof. The form 13 may be made of concrete, or any material desired, with the textured surface thereon molded or chiseled into the surface to form a random or special textured surface 14. The form 13 has a slightly smaller outside circumference than the inside circumference of the tube 10. Tube 10 normally comes in fixed inside diameter but since typically three tubes are shipped, one inside the other, there is a slight variation in the inside and outside circumferences. The form 14 is thus sized to be slightly smaller than the smaller of the any tubes shipped together as one size since the elastomer sleeve of the present invention will expand to the inside dimension of any of the three tubes.

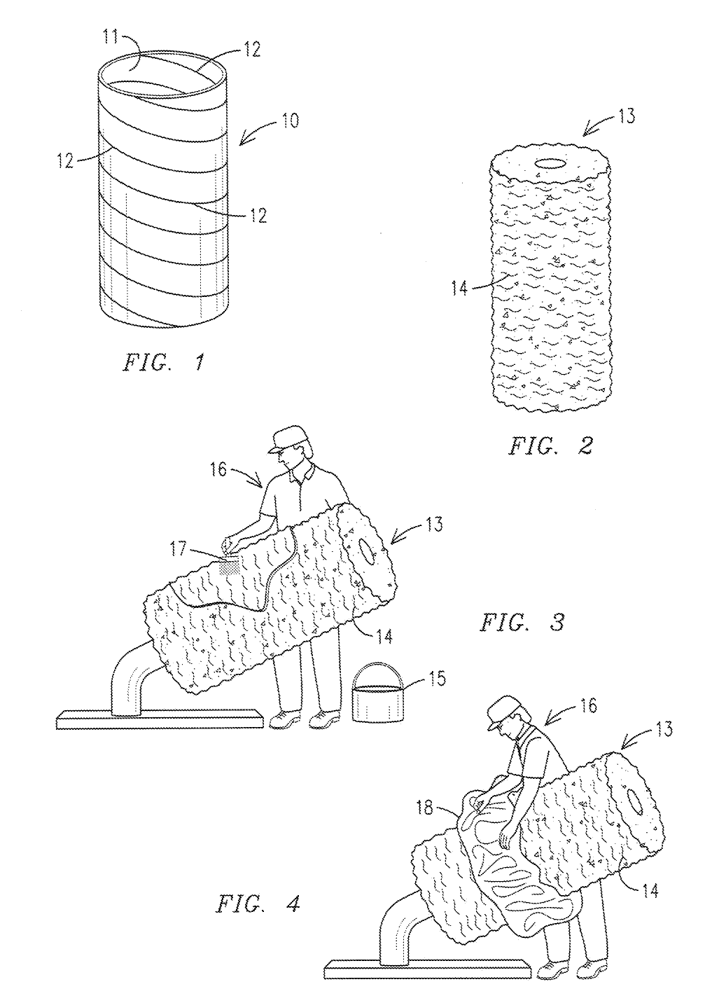

In FIG. 3, a mixture of a liquid elastomer, such as a liquid latex or a liquid silicone, is mixed with a rigid granular material, such as a granular pumice, in the container 15. A workman 16 is using a brush 17 to apply the mixture from the container 15 onto the textured surface 14 of the form 13. Coating the form 14 with the liquid elastomer and rigid granular material randomly disperses the rigid granular material over the form 13 surface 14. The liquid elastomer is allowed to cure forming a flexible and compressible sleeve having the randomly dispersed rigid granular material encapsulated therein. The flexible and compressible sleeve 18 is shown being removed from the form 13 by the workman 16 in FIG. 4.

As seen in the sectional view of FIG. 5, the flexible and compressible sleeve 18 has the flexible and compressible elastomer having the rigid granular material 21 randomly encapsulated therein and may have a colorant applied to the surface 22 thereof. The sleeve 18 may be a latex or silicone elastomeric polymer 20 while the rigid granular material may be a granular pumice.

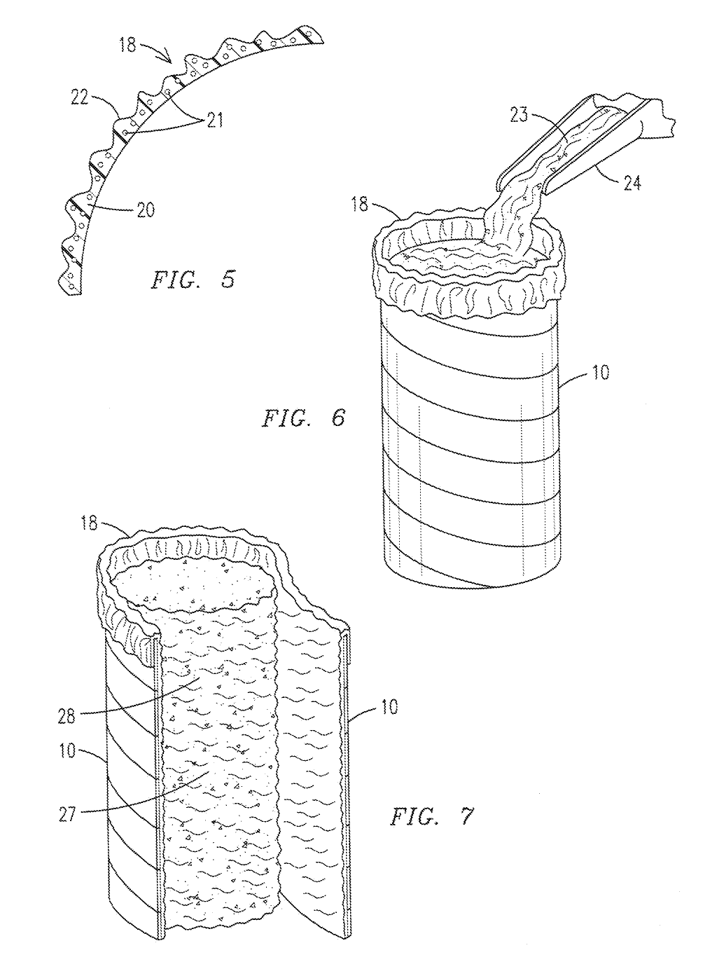

The elastomeric sleeve 18 is shown attached to the inside of the concrete column forming tube 10 in FIG. 6 to line the interior surface 11 of the tube 10. The tube 10 is being filled with concrete 23 from a chute 24 in FIG. 6. The pressure of the fluid concrete in the sleeve lined tube 10 compresses the sleeve 18 walls and presses against the rigid granular material creating a texture in the concrete upon the curing of the concrete. The concrete 23 within the concrete column forming tube compresses the flexible and compressible elastomeric sleeve 18 walls to push the concrete against the rigid granular material 21 to form a texture on the exterior surface 27 of the formed concrete column 28 as seen in FIG. 7. The surface of the sleeve 18 may have a colorant coated thereover which is imparted to the finished concrete column 28. This allows a column to be formed in a standard concrete column forming tube with a desirable and esthetic texture and color rather than the concrete surface of most concrete columns.

The concrete column forming tube 10 and the flexible and compressible sleeve 18 is being removed from the cured concrete column 28 in FIG. 7. This can be accomplished by merely cutting the paper board tube 10 and sleeve 18 and pulling the tube and sleeve from the cured concrete column 28 having a textured surface 27.

The flexible and compressible sleeve 18 is made of a liquid elastomer having a randomly dispersed rigid granular material 21 encapsulated therein and shaped to be slightly smaller than the inside circumference of a concrete column forming tube. The sleeve 18 may also be coated with a colorant for lining a concrete forming tube to form a concrete column with a textured and colored surface 27. The granular material can be a pumice or other irregular shaped rigid granular material which is unevenly dispersed throughout the elastomer sleeve 18 to give the concrete column surface an irregular textured surface 27 which may also have a colored surface.

It should be clear at this time that a method and apparatus have been provided for forming a concrete column 28 having a textured and colored surface 27. However, it should be clear that the present invention is not to be considered as limited to the forms shown which should be considered illustrative rather than restrictive.

I claim:

1. A process of forming a concrete column comprising the steps of:
selecting a rigid elongated concrete column forming tube having a generally smooth interior wall;
selecting a tubular form having a textured surface thereon and sized smaller than the inside circumference of the selected concrete forming tube interior wall circumference;
mixing a rigid granular material in a liquid elastomer;
coating the selected tubular form exterior textured surface with said mixture of liquid elastomer and rigid granular material to randomly disperse said rigid granular material over the surface of said tubular form textured surface;
curing said liquid elastomer having the rigid granular material therein to form a flexible and compressible elastomer sleeve having rigid granular material randomly dispersed therein;
removing said elastomer sleeve from said tubular form;
attaching the inside of said selected concrete column forming tube with said compressible elastomer sleeve;
pouring concrete into said concrete column forming tube having said compressible elastomer sleeve attached therein; and
curing the concrete poured into said concrete column forming tube to form a concrete column having a textured surface;
whereby a concrete column is formed with a textured surface.

2. The process of forming a concrete column in accordance with claim 1 including the step of applying a colorant to the inside surface of said elastomer sleeve prior to pouring concrete into said said column forming tube whereby a concrete column is formed with a textured and colored surface.

3. The process of forming a concrete column in accordance with claim 1 including the step of removing said concrete column forming tube and attached elastomer sleeve from said cured concrete column.

4. The process of forming a concrete column in accordance with claim 3 in which said liquid elastomer is a liquid latex elastomer.

5. The process of forming a concrete column in accordance with claim 3 in which said liquid elastomer is a liquid silicone elastomer.

6. The process of forming a concrete column of in accordance with claim 3 which said a rigid granular material is a granular pumice.

7. The process of forming a concrete column in accordance with claim 5 including the step of cutting said concrete column forming tube and attached elastomer sleeve from said cured concrete column.

8. A flexible and compressible mold lining for a concrete column forming tube comprising:
a flexible and compressible elastomer sleeve having randomly dispersed rigid granular material encapsulated therein and having a colorant on the inside surface thereof and shaped to fit inside of a concrete column forming tube to thereby form a tube lining sleeve that will compress the elastomer sleeve upon concrete being poured into said concrete column forming tube and against the randomly dispersed rigid granular material encapsulated therein whereby a concrete column can be formed having a textured and colored surface.

9. The flexible and compressible mold lining for a concrete column forming tube apparatus in accordance with claim 8 in which said flexible and compressible elastomer sleeve is a flexible and compressible latex sleeve.

10. The flexible and compressible mold lining for a concrete column forming tube in accordance with claim 9 in which said rigid granular material is a granular pumice.
